(19) United States
(12) Patent Application Publication
(10) Pub. No.: US 2007/0245001 A1
(43) Pub. Date: Oct. 18, 2007

(54) System and Method for Administrating Electronic Documents

(75) Inventor: Magnus Bjork, Stockholm (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Comex Electronics AB, Taby (SE)

(21) Appl. No.: 10/581,153

(22) PCT Filed: Nov. 30, 2004
(86) PCT No.: PCT/SE04/01773

§ 371 Date: Feb. 13, 2007

(30) Foreign Application Priority Data
Dec. 2, 2003 (SE) 0303243-0

(51) Int. Cl. G06F 17/30

(52) U.S. Cl. 709/223

(57) ABSTRACT

System for administrating at least one electronic document, the system comprising: a communication terminal (105) adapted for communication with a server (115) via a network (110), said server being adapted for communication with a database (120), wherein the electronic document comprises a first information entity and a second information entity, wherein the communication terminal (105) is arranged to display the first and the second information entity in dependence of each other and to provide information to the second information entity, wherein said communication terminal further is arranged to generate a third information entity comprising at least part of the first and second information entity and the provided information by converting means, wherein said communication terminal further is arranged to make the third information entity unique, and wherein said server is adapted to transmit at least a part of the unique third entity to a receiving unit (120; 130).

The present invention relates to a system for administrating electronic documents.

The present invention also relates to a method for administrating electronic documents.

The present invention further relates to a computer program for carrying out such a method.

### BACKGROUND OF THE INVENTION

Ours is a society undergoing massive, revolutionary change in every sphere—economic, demographic and especially cultural. Traditional boundaries are blurring and shifting. We are successively adjusting to an international role. Individual citizens expect public administration to match the rest of society in terms of accessibility, interaction and collaboration. For many, it is now self-evident that services and goods should be available round the clock, everywhere, regardless of office hours and geographical barriers. To maintain the provision of good, equivalent services, public administration is now undergoing rationalization and renewal.

The modern world is filled with forms and the like, leading to a never-ending administration of papers. There is thus the desire to reduce the paperwork, and also to make the administration of papers more efficient. The wide spread use of networks such as the Internet has provided a possibility to electronically handle administration of papers such as forms and the like. Public administration is moving into homes and businesses. Accessibility, irrespective of office hours and location is thus becoming a reality.

To make use of advanced services, users must be able to sign documents electronically. Unauthorized access to sensitive information must be prevented and document filing made possible. In this area, common standards are being devised to create an infrastructure for secure identification and signature.

From SE C2 518 978 is known a system for accessing, processing and transferring data files comprising a universal, wide spread network, a database system, a local data processing system, a server and receiving system. A user obtains access to the database, with files such as standard forms, which are downloaded, by using a local computer via the network. The user then edits the downloaded files on the screen, e.g. by completing the forms, and transfers them to the server via the network. Each file is preferably transferred in encrypted form and comprises preferably an attached digital signature. Encryption with public code is preferably used both for encryption of transferred forms and for implementing of the digital signature. After processing in the server of such decoding identification and user identification the server transmits the transferred file to the correct receiving system.

A disadvantage with the above system is that downloading files is somewhat tricky, i.e. not particularly user friendly, takes additional time, and adds a source of error to the administration of papers. Downloading files is also an additional safety issue as files may be corrupted, viruses spread etc.

### SUMMARY OF THE INVENTION

An object of the present invention relates to the problem of improving the administration of electronic documents by making it more user friendly, safer, and less time consuming. This is achieved according to the characterizing part of claim 1.

An advantage with not having to download documents to the computer is that disk space is reduced. A further advantage is that communication becomes safer as the risk of receiving corrupted files or viruses is reduced. Advantageously the source of error present when downloading files is eliminated. A further advantage with the present invention is the possibility of working off-line, which means that there is no time pressure, i.e. reduces on-line costs, and it is safer as there is no risk of being attacked by hackers during that time. Yet another advantage is the use of existing technique, which reduces costs. A general advantage is that the public and companies will have access to electronic documents such as forms round the clock, and further that the paperwork is substantially eliminated. The administration of documents thus becomes more cost efficient.

Preferably the method further comprises the features of claim 2.

### BRIEF DESCRIPTION OF THE DRAWINGS

FIG. 1a illustrates schematically a system for administrating electronic documents according to an embodiment of the present invention.

FIG. 1b illustrates schematically a system for administrating electronic documents according to an embodiment of the present invention.

FIG. 2a illustrates an electronic file according to an embodiment of the invention.

FIG. 2b illustrates schematically an electronic file according to an embodiment of the invention.

FIG. 3a illustrates schematically data stored in a memory according to an embodiment of the present invention.

FIG. 3b illustrates schematically data stored in a memory according to an embodiment of the present invention.

FIG. 4 illustrates schematically software modules according to an embodiment of the present invention.

FIG. 5 illustrates schematically a method for administrating electronic documents according to an embodiment of the present invention.

FIG. 6 illustrates schematically a more detailed method for administrating electronic documents according to an embodiment of the present invention.

FIG. 7 illustrates an electronic device according to an embodiment of the present invention.

### DETAILED DESCRIPTION OF THE DRAWINGS

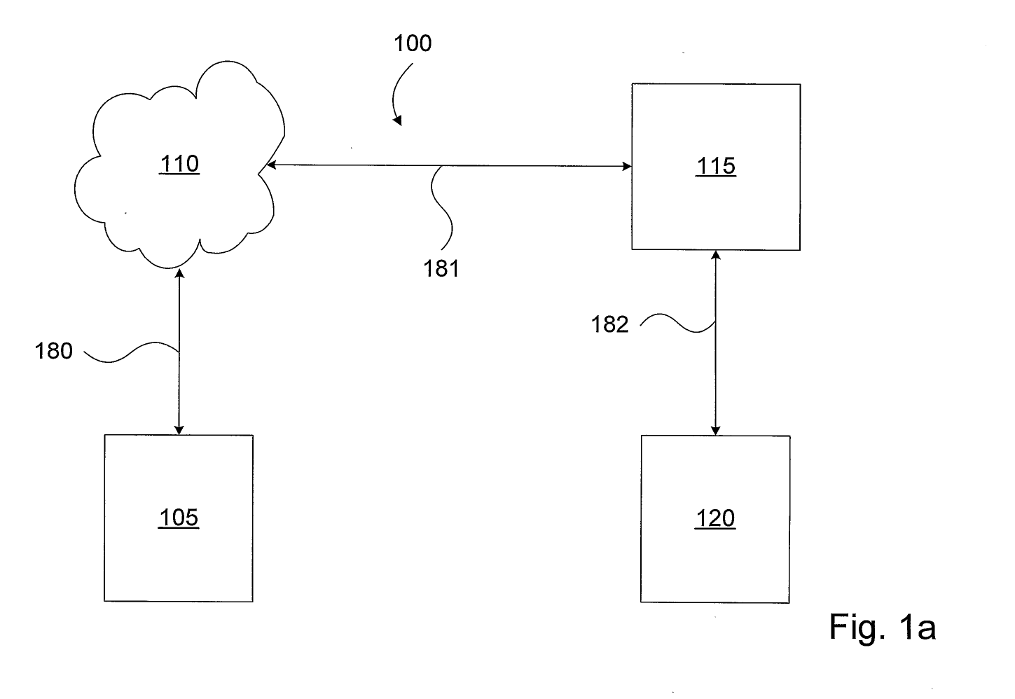

FIG. 1a illustrates a system 100 for administrating electronic documents according to an embodiment of the invention.

The system 100 comprises a communication terminal 105. The communication terminal is adapted for communication with a network 110 via a data link 180. The network 110 is adapted for communication with a server 115 via a data link 181. The server 115 is adapted for communication with a database 120 via a data link 182. The data links referred to herein may be wireless.

The communication terminal 105 may be a personal computer (PC). The communication terminal can be a portable computer, a Personal Digital Assistant (PDA), a cellular phone, or other. The communication terminal may comprise a web browser. The communication terminal is provided with a display unit, such as a monitor or a display screen. The communication terminal is also provided with an input unit, such as a keyboard or keypad. The input unit may be voice or light controlled. The input unit may have a marker controller, such as a mouse, track pad, track ball or the like. The user can use the input unit so as to feed information to fields on a displayed form. The communication terminal may further comprise a memory unit, an output unit and a processing unit.

A user of the system 100 can download a component comprising an application for electronic signature from the server 115 to the communication terminal 105 via the network 110. This can be performed before the user starts the procedure to use the system according to the invention. The component may be installed automatically on the communication terminal 105.

The network 110 is a data communication network. The network 110 may be a Wide Area Network (WAN). The network 110 may be a Wireless Local Area Network (WLAN). Preferably the network is the Internet.

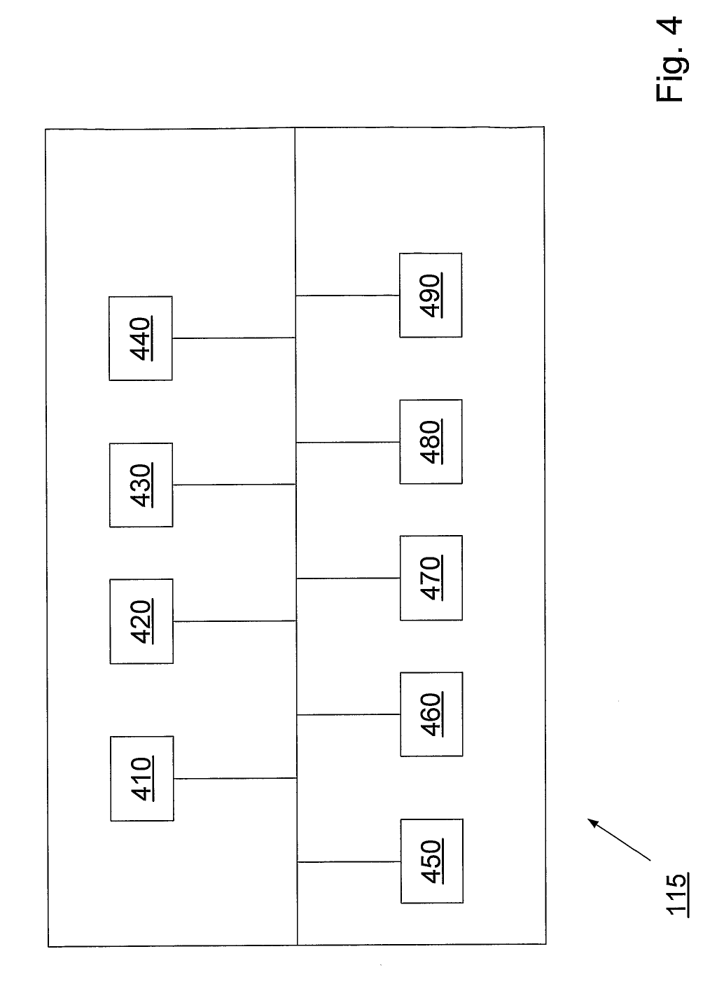

The server 115 will be further described in detail with reference to FIG. 4.

The database 120 comprises a plurality of files. According to a preferred embodiment the files are XML- and HTML-files. Each HTML-file is created in dependence of a specific blank. The specific blank preferably is a physical blank, also referred to as form, is scanned in a conventional manner by means of a scanner. The electronic file created by the scanning process is referred to as a framework. The framework forms a part of an HTML document.

The data base 120 further comprises at least one overlay. The overlay may be an XML-file. Each framework has a corresponding overlay. The overlay is to be described in greater detail below.

Further, the database 120 comprises a table, which contains registered users of the system 100. The table is dynamic and, thus, users may be added or deleted by an administrator of the system. Each user has access to a number of objects stored in the database 120. The objects may contain information of various kinds. One object may typically be said framework or said overlay. According to one embodiment, mutually different users may have common access to an object. According to another embodiment, mutually different users may have simultaneously common access to an object.

In a preferred embodiment of the invention, the user of the system is requesting a web-site having a specific URL-address (Uniform Resource Locator) via the communication terminal 105. The user can log on by using a specific certificate, such as an X509-certificate or other. This may be performed by means of a smart card. If the user is successful in the log on procedure an SSL-connection (Secure Sockets Layer) is established between the web-browser, which is provided in the communication terminal 105, and the server 115. Alternatively, IP-tunneling such as IP Security (IPSec), Point to Point Tunneling Protocol (PPTP) and Layer 2 Tunneling Protocol (L2TP), or the like, may be used.

The user requests a specific electronic form, which the user intends to fill out. The form is displayed on the display by the web browser. The form comprises the framework and the corresponding overlay. The framework is provided in a background of a web browser window. The overlay, which has predefined form fields corresponding to the structure of the framework, is provided in a layer above the framework. The overlay may appear as a transparent or semi-transparent layer, which is aligned with the framework in a pre-defined manner.

The user fills out one or several fields in the overlay by using the input unit. In a next step a control of the information provided by the user to the field is performed by means of the web browser. An XML-file comprising information corresponding to the overlay, framework and the provided information is generated. The electronic form is then converted to XML format by means of a local application, which is activated by the user. The application further adds a digital signature to the generated XML-file. The electronically signed XML-file is uploaded to the server 115 where it may be processed before final storage in the object table provided data base 120.

According to one embodiment a user can order a specific form as described above. The user can further choose to disconnect the communication terminal 105 from the network 110 while the form is filled out. This means that the established secure communication path between the communication terminal and the server 115 is not active or connected. After the form is filled out a new secure communication path is established. Control and conversion of the filled out electronic document is performed as described above, as well as processing performed in the server and storage of the generated XML-file.

According to one embodiment a user may fill out the form step by step, which also can mean that a control of the information provided by the user to a particular information field of the overlay is performed one at the time. In order for a user to be able to fill out a subsequent data field of the overlay, the foregoing data field must be correct according to a predetermined demand. The control of filled out data fields of the overlay may alternatively be performed in the server 115.

According to yet another embodiment a user may chose in what order he or she wants to fill out the fields of the overlay. It is further possible to interrupt a procedure of filling out the fields of information of the overlay and resume the procedure later on.

According to a further embodiment an electronic form having one or more data fields in the overlay, which fields are to be filled out, are sent in dependence of information provided by the user in a foregoing overlay of an electronic form. This means that an interactive service is provided according to the present invention. This is also referred to as question-answer model.

According to the invention, data structures of the overlay are connected to data structures of the framework and a digital signature is applied to a combination of the two so as to achieve an imperative document.

FIG. 1b illustrates an alternative embodiment of a system for administrating electronic documents according to an aspect of the invention. The system 100 illustrated in FIG. 1a constitutes a part of a system 101 illustrated in FIG. 1b.

A firewall 125 is provided between the network 110 and the server 115. The firewall is adapted for communication with the network 110 and server 115 by data links 181a and 181b, respectively. The firewall is arranged so as to prevent undesired data communication between the network 110 and the server 115. In particular the firewall is arranged so as to prevent encroachment.

A network 140 is provided in conjunction with the system 100. According to one embodiment the network 140 is an intranet. The network 140 is adapted for communication with the database 120 via a data link 186. Two communication terminals 145 and 150 are adapted for communication with the network 140 via data links 186 and 187, respectively. Although only two communication terminals are shown in the figure a plurality of communication terminals may be connected to the intranet 140.

A communication terminal 160 is directly connected to the database 120 via a data link 189. Alternatively, a plurality of communication terminals may be directly connected to the database 120.

Also illustrated in the figure is a communication terminal 130 connected to the network 110 via a data link 183. A communication terminal 135 is connected to the server 115 via a data link 184.

According to one embodiment an authorized user may have access to the filled out electronic forms, which are stored in the database 120 by means of the communication terminal 160. The authorized user may be an employee of an authority or a private company using information stored in the database 120.

According to one embodiment authorized users may have access to the filled out electronic forms, which are stored in the database 120, by means of the communication terminals 145 and 150 via the intranet 140. The authorized users may be employees of an authority or a private company using information stored in the database 120.

According to one embodiment an authorized user may have access to the filled out electronic forms, which are stored in the database 120, by means of the communication terminal 130. The authorized user may be an employee of a second authority functioning as a control authority, such as the police or a tax authority.

An authorized user may have access to the server by means of communication terminal 135. The authorized user may be a privileged administrator of the server.

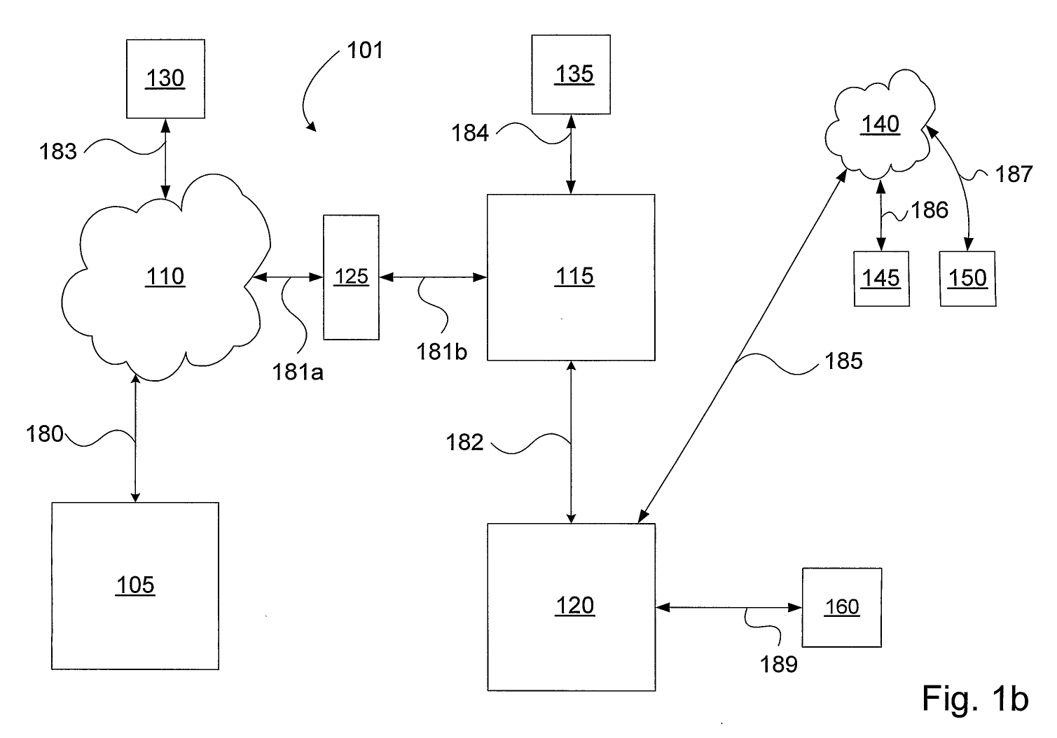

FIG. 2a illustrates a framework 200 according to an embodiment of the invention. The framework 200 has a structure corresponding to for example a physical form bear upon a number of predefined fields.

According to one embodiment the framework is an HTML file comprising a number of primary data fields, such as text strings comprising questions and/or instructions. Illustrated in FIG. 2a are primary data fields 210, 230, 250 and 270. Each primary data field has a corresponding primary information field 220, 240, 260 and 280, respectively. The primary information fields are blank or partial blank fields in which information in dependence of a content in the corresponding primary data field is originally supposed to be provided (on the physical blank). Alternatively, the primary data fields comprises data representing pictures, graphs, symbols or other, or a combination thereof. Alternatively, the primary information fields are arranged as a check cross field, in which the user can make a check mark, so as to indicate that the content in the corresponding primary data fields is correct (or incorrect). It should however be noted that no information is provided by the user in the primary information fields but in a corresponding secondary data field in the overlay as will be discussed below.

FIG. 2b illustrates an overlay 201. According to an embodiment of the invention the overlay 201 is an XML-file comprising secondary data fields 221, 241, 261 and 281, which are corresponding to the primary information fields 220, 240, 260 and 270, respectively.

Control data fields 222, 242, 262 and 282 comprises information about demands on the information fed by the user to the secondary data fields 221, 241 and 261, respectively. The demands may be that specific characters must be used or that only text strings or numbers must be used. The demands may further concern a length of text strings, language, spelling and other. Further, definitions of control procedures, which are to be performed are provided in said data fields 222, 242, 262 and 282. The control procedures are performed in the communication terminal 105. Alternatively, the control procedures are performed in the server 115.

According to an alternative embodiment of the invention only one control data field is provided in the overlay 201. Said control data field comprises information about demands on the information fed to all the secondary data fields 221, 241, 261 and 281.

The component 215 is a compiled application. The component can be called by the web-browser. The component 215 is used to provide intelligence to the electronic document. A part of the component 215 can be an Active X component. A first part of the component 215 is adapted to manage encryption processes. The first component part can, according to a preferred embodiment be an Active X component. It should be noted that the part of the component, which manages encryption processes, can be part of prior art technique.

A second part of the component 215 is adapted to convert data provided in the overlay 201, framework 200 and the data provided by a user of the communication terminal 105 to XML format.

A code segment for managing data of the overlay 201, framework 200, and the data provided by a user of the communication terminal 105, and to apply the second part of the component 215 is provided in the component 215.

An extract of the code segment is shown below.

<?XML version “1.0” encoding=“UTS-8”?>
<Fieldname1 X=X_posfield1
Y=Y_posfield1>Fielddata1</Fieldname1>
<Fieldname2 X=X_posfield2
Y=Y_posfield2>Fielddata2</Fieldname2>
.
.
<FieldnameN X=X_posfieldN
Y=Y_posfieldN>FielddataN</FieldnameN>
<BITMAP>Unicode-formatted screendata<BITMAP>

A sign component 216 is adapted to initiate the electronic signature of the generated XML-file. The user can actively sign the generated XML-file by activating the component by clicking on a corresponding button provided in the displayed overlay 201 using e.g. a mouse. The sign component 216 when activated is in its turn activating the component 215 so as to sign the XML-file.

A send component 217 is adapted to send the signed generated XML-file to the server 115. The user can actively send the signed generated XML-file to the server 115 activating the component by clicking on a corresponding button provided in the displayed overlay 201 using e.g. a mouse.

Alternatively, the sign component 216 and send component 217 may be integrated in one component, which can be activated by activating one corresponding button. Alternatively, the component 215 can be activated so as to perform generation of the XML-file and to electronically sign the generated file automatically when a predefined criterion is fulfilled with reference to how the information is provided to the overlay 201.

Alternatively, the secondary data fields 221, 241, 261 and 281 are partly filled out by a set-up mechanism module provided in the server 115. The set-up mechanism module is further described with reference to FIG. 4. If the secondary data fields are partly filled out, the pre-provided information may correspond to information provided in the information fields 220, 240, 260 and 280. Alternatively, the pre provided information may not correspond to information provided in the information fields 220, 240, 260 and 280 but being added to the secondary data field. According to one embodiment the user may actively change or correct the pre-provided information in the secondary data fields.

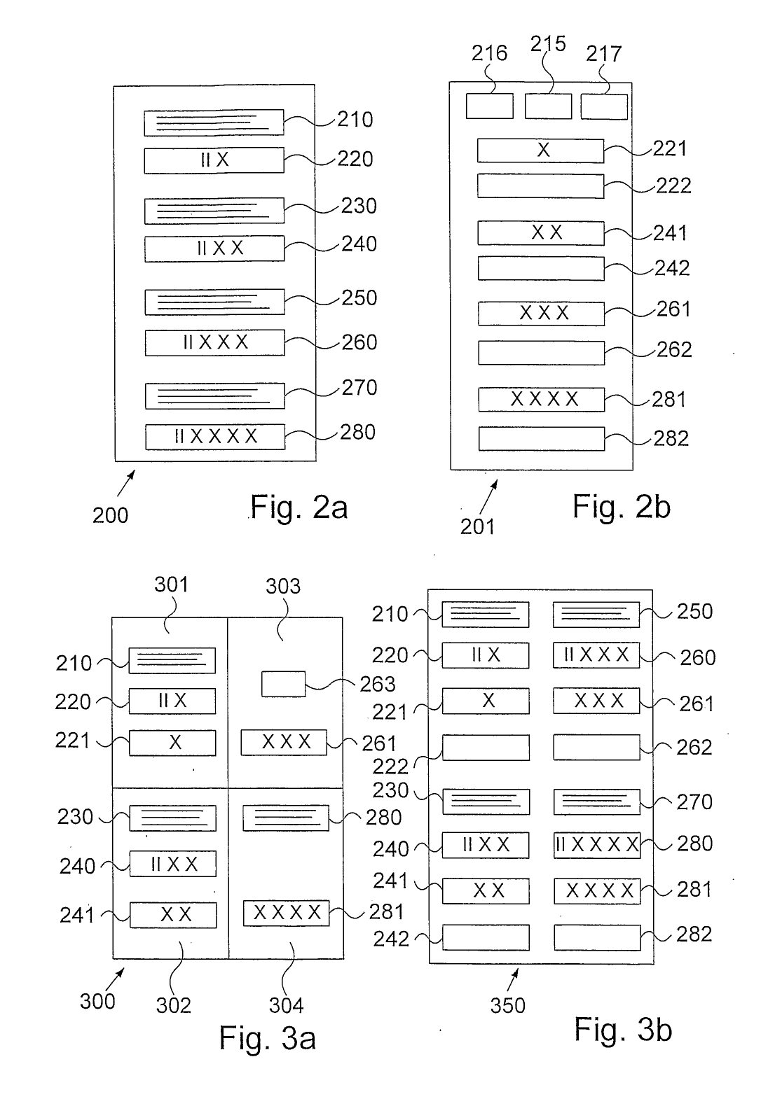

FIG. 3a illustrates a persistent memory location 300 preferably provided in the database 120. The memory location 300 comprises a plurality of sub memory locations of which four are illustrated. The illustrated sub memory locations are referred to as 301, 302, 303 and 304.

The sub memory location 301 comprises primary data field 210, primary information field 220 and secondary data field 221. The sub memory location 302 comprises primary data field 230, primary information field 240 and secondary data field 241.

Groups of primary data fields, primary information fields and secondary data fields could be stored as above, being directed towards groups of 250, 260, 261 and 270, 280 and 281 but various alternatives may of course be provided.

For example, the sub memory location 303 comprises a data field 263 in which adequate pointers are provided so as to connect the secondary data field 261 with the primary data field 250. Alternatively, a sub memory location may comprise a primary data field and a corresponding secondary data field. This is exemplified with reference to sub memory location 304, in which the primary data field 270 and the secondary data field 281 is stored.

FIG. 3b illustrates a memory location 350 comprising data fields with reference to FIG. 2a and FIG. 2b. According to one embodiment all data fields corresponding to one form are stored in one memory location.

FIG. 4 illustrates software modules stored in a memory in the server 115. The modules can be written in for example Java, C++, HTML or other.

The server 115 is adapted to read a certificate attribute and perform a comparison procedure so as to identify a user, who intends to use one or several services provided by the server.

An authentication module 410 is provided so as to control an authentication procedure of the user. The identity of the user may be established by this module.

An authorization module 420 is provided so as to establish what objects the user has access to.

A set-up mechanism 430 is provided to partly fill out the secondary data fields 221, 241, 261 and 281 so as to facilitate and reduce the amount of work required of a user who is using the system 100 alternatively 101.

An invoicing module 440 is provided so as to control and administrate applications for which payments have to be performed.

A document managing module 450 is provided so as to manage transmission and receiving of electronic documents.

An administrator control module 460 is provided so as to render a possibility for the administrator to manage the server 115.

A module 470 is adapted to handle logging procedures. The user of the system hereby has the possibility to check status of a document treated by e.g. an authority.

Module 480 is an electronic document version updating module capable of updating frameworks and corresponding overlays.

A time stamp module 490 manages a time stamp procedure. The time stamp is applied to the electronic document in question using a certificate of the server. The electronic document is further digitally signed. Hereby it is imperative that the server has received the electronic document.

The software modules stored in the memory in the server 115 are not limited by the modules described with reference to FIG. 4.

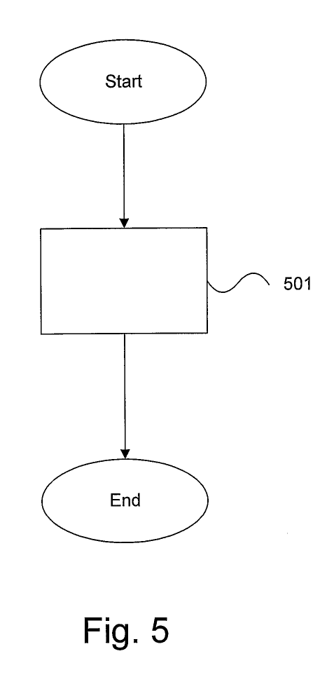

FIG. 5 illustrates a method for administrating electronic documents according to an aspect of the invention. A step s501 comprises a method for administrating at least one electronic document, characterized by the steps of:
requesting the electronic document, which document comprises a first and a second information entity,
displaying said first and a second information entity in dependence of each other,
providing information to said second information entity,
generating a third information entity, which entity comprises information related to said first and second information entities and the provided information,
making the third information entity unique, and
transmitting said unique third entity.

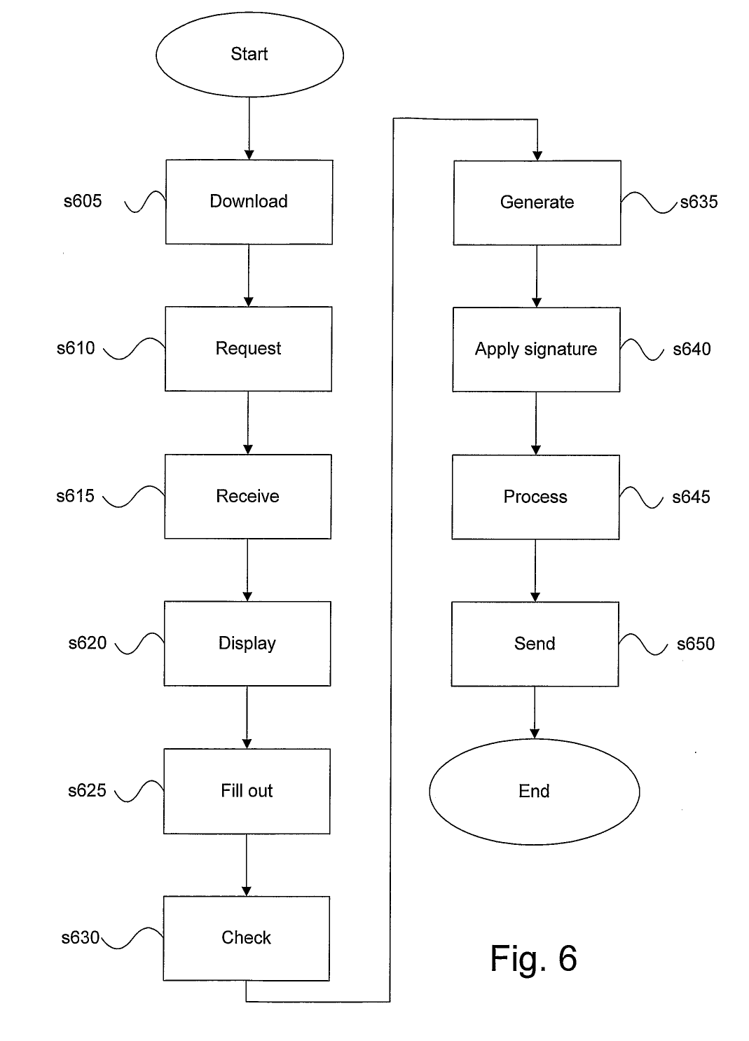

FIG. 6 illustrates a method in further detail according to an aspect of the invention.

According to a first method step s605 a user of the system 100 alternatively 101 download a component from the server 115 to the communication terminal 105 via the network 110. Alternatively, the component is pre-installed on the communication terminal.

In a step s610 the user requests a specific URL-address provided by the server 115 so as to get access to a specific form. The server 115 receives 615 an electronic document, which corresponds to the specific desired form, from the database 120 and the web-browser, provided in the communication terminal, is displaying s620 the electronic document as described above, i.e. the web-browser visually provides the framework and the corresponding overlay so as to make possible for the user to fill out s625 the secondary data fields of the overlay.

After the user has filled out one or several secondary data fields the provided information is checked s630 whether it is correct according to predetermined demands, as described above. If the provided information is not correct a message will be displayed containing an adequate instruction, which will support the user to correct the provided information.

The step s630 is followed by a step wherein an XLM-document is generated s630. The generated XLM-document comprises data from the framework and the overlay as well as the provided information. This is performed by activating the component 215 with reference to FIG. 2b.

A digital signature is created s640 so as to make the generated XML-document unique. This is performed when the first part of the component 215 is processing the XML-document. The certificate provided in the communication terminal has a private key used in the process. The certificate can be provided on a smart card reachable via a card reader. Alternatively, the certificate can be provided in the communication terminal. If several certificates are provided, the user may chose which certificate to use. The first component is adapted to call the certificate.

A hash sum based on data in the generated XML-document is generated. The hash sum is then encrypted and added to the end of the generated XML-document.

The step s640 is performed in the communication terminal 105 and is initiated by the web-browser.

The server 115 is in a next step processing s645 the generated digitally signed XML-document in accordance with the configured software stored therein. The processing procedure may comprise subroutines such as invoicing and data processing, so as to later store the content of the generated XML-file in a particular way.

Verification of the authenticity of the digitally signed XML-document is performed using a corresponding hash sum.

Decryption of the electronically signed document may be performed so as to process data thereof.

In a next step the server sends s650 the generated digitally signed XML-file, or particular parts thereof, to the database for storage in accordance with FIG. 3a and/or FIG. 3b. Thereafter the method ends.

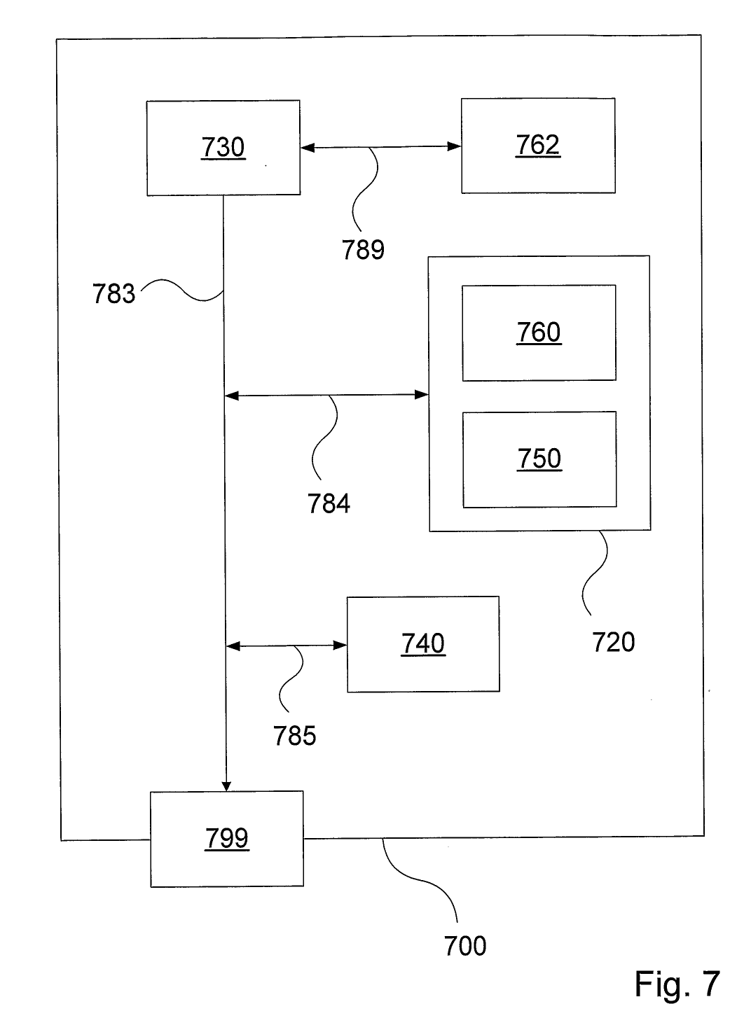

With reference to FIG. 7 there is shown a diagram of one way of embodying an apparatus 700. The above mentioned communication terminal 105 and server 115 may include an apparatus 700. The apparatus 700 comprises a non-volatile memory 720, a data processing device 730 and a read/write memory 740. The memory 720 has a first memory portion 750 wherein a computer program, such as an operating system, is stored for controlling the function of the apparatus 700. Further, the apparatus 700 comprises a bus controller, a serial communication port, I/O-means, an A/D-converter, a time date entry and transmission unit, an event counter and an interrupt controller (not shown).

The data processing device 730 may be embodied by, for example, a microprocessor.

The memory 720 also has a second memory portion 760, where software modules with reference to FIG. 4 are stored. In another embodiment the software modules with reference to FIG. 4 are stored on a separate non-volatile recording medium 762. The program may be stored in an executable manner or in a compressed state.

When it is described that the data processing device 730 performs a certain function this is to be understood that the data processing device 730 performs a certain part of the program which is stored in the memory 760 or a certain part of the program which is stored in the recording medium 762.

The data processing device 730 may communicate with a data port 799 by means of a data bus 783. The memory 720 is adapted for communication with the data bus 783 via data bus 785. The separate non-volatile recording medium 762 is adapted to communicate with the data processing device 730 via data bus 789. The read/write memory 740 is adapted to communicate with the data bus 783 via a data bus 785.

Parts of the methods described with reference to FIGS. 5 and 6, respectively, can be performed by the apparatus 700 by means of the data processing device 730 running the program stored in the memory portion 760. When the apparatus 700 runs the program parts of the method described with reference to FIG. 5 and/or FIG. 6 is executed.

When data is received on the data port 799 said input data is temporarily stored in the read/write memory 740. When the received input data have been temporarily stored, the data processing device is set up to perform execution of code in a manner described above.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. System for administrating at least one electronic document, the system comprising:
a communication terminal (105) adapted for communication with a server (115) via a network (110), said server being adapted for communication with a database (120),
characterized in that,
the electronic document comprises a first information entity and a second information entity, wherein
the communication terminal (105) is arranged to display the first and the second information entity in dependence of each other and for providing information to the second information entity, wherein
said communication terminal further is arranged to generate a third information entity comprising at least part of the first and second information entity and the provided information by converting means, wherein
said communication terminal further is arranged to make the third information entity unique, and wherein
said server is adapted to transmit at least a part of the unique third entity to a receiving unit (120; 130).

2. System according to claim 1, characterized in that said second information entity is created in dependence of said first information entity.

3. System according to claim 1 or 2, characterized in that the first information entity and the second information entity are mutually different.

4. System according to claim 1-3, characterized in that the first information entity is an HTML-file.

5. System according to claim 1-4, characterized in that the second information entity is an XML-file.

6. System according to claim 1-5, characterized in that the third information entity is an XML-file.

7. System according to claim 1-6, characterized in that the communication terminal is adapted to display the first and the second information entity by means of a web-browser.

8. Method for administrating at least one electronic document, characterized by the steps of:
requesting the electronic document, which document comprises a first and a second information entity,
displaying said first and a second information entity in dependence of each other,
providing information to said second information entity,
generating a third information entity, which entity comprises information related to said first and second information entities and the provided information,
making the third information entity unique, and
transmitting said unique third entity.

9. Method according to claim 8, characterized by
making said third information entity unique by applying a digital signature.

10. Method according to claim 8 or 9, characterized by
displaying said first and a second information entity such that they are aligned in a predetermined way.

11. Method according to claim 8-10, characterized by displaying said first and second information entity by means of a web-browser.

12. Computer programme comprising a programme code for performing the method steps of claim 8-11 when said computer programme is run on a computer.

13. Computer programme product comprising a program code stored on a, by a computer readable, media for performing the method steps of claim 8-11, when said computer programme is run on the computer.

14. Computer programme product directly storable in an internal memory into a computer, comprising a computer programme for performing the method steps according to claim 8-11, when said computer programme is run on the computer.
